(19) United States
(12) Patent Application Publication
(10) Pub. No.: US 2021/0188717 A1
(43) Pub. Date: Jun. 24, 2021

(54) REINFORCED CERAMIC MATRIX COMPOSITE AND METHOD OF MANUFACTURE

(71) Applicant: United Technologies Corporation, Farmington, CT (US)

(72) Inventors: Michael R. Kracum, Manchester, CT (US); David C. Jarmon, Hendersonville, NC (US)

(21) Appl. No.: 16/723,360

(22) Filed: Dec. 20, 2019

(51) Int. Cl. C04B 35/71; F01D 5/28

(52) U.S. Cl. CPC C04B 35/71; F01D 5/282; C04B 2235/616; C04B 2235/5252; C04B 2235/614; C04B 2235/48; C04B 2235/661

(57) ABSTRACT

A method of making a ceramic matrix composite is disclosed. According to the method, a first preform comprising fibers is formed, and a second preform including a helical surface portion is inserted into the first preform. The first preform with the inserted second preform is infiltrated with a matrix material comprising a ceramic to form the ceramic matrix composite. A ceramic matrix composite is also disclosed. The ceramic matrix composite includes a first portion including a matrix comprising a ceramic, and a reinforcement including fibers derived from the first preform in the matrix. A second portion including a helical surface portion interface with the first portion is disposed within the first portion.

### BACKGROUND

Exemplary embodiments pertain to the art of ceramic matrix composites.

Ceramic matrix composites (CMC) can be formed by infiltrating a preform with a matrix material such as by chemical vapor infiltration to form the matrix. Ceramic matrix composites have high temperature capability and are light weight, and are an attractive material for various applications in which high temperature durability and light weight are desired. Based on these and other features, there remains a desire and need for alternate methods and materials for ceramic matrix composites.

### BRIEF DESCRIPTION

A method of making a ceramic matrix composite is disclosed. According to the method, a first preform comprising fibers is formed, and a second preform including a helical surface portion is inserted into the first preform. The first preform with the inserted second preform is infiltrated with a matrix material comprising a ceramic to form the ceramic matrix composite.

In addition to one or more of the features described above, or as an alternative to any of the foregoing embodiments, the first preform can comprise a three-dimensional woven fiber preform or a stacked fiber layup.

In addition to one or more of the features described above, or as an alternative to any of the foregoing embodiments, the first preform can comprise a stacked layup of fibers including a Z-axis perpendicular to layers in the stacked layup, and the second preform is inserted with a helical axis of said helical surface portion arranged parallel to the Z-axis.

In addition to one or more of the features described above, or as an alternative to any of the foregoing embodiments, the method can further comprise rotating the second preform about an axis of the helix in a rotational direction that promotes advancement of the helical surface through the first preform.

In addition to one or more of the features described above, or as an alternative to any of the foregoing embodiments, axial movement of the second member with said insertion can be equal to axial distance traveled by said helical surface portion in response to said rotation.

In addition to one or more of the features described above, or as an alternative to any of the foregoing embodiments, the helical surface portion can include a portion arranged as a screw.

In addition to one or more of the features described above, or as an alternative to any of the foregoing embodiments, the helical surface portion can include a helical portion arranged as a spring.

In addition to one or more of the features described above, or as an alternative to any of the foregoing embodiments, the second preform can be inserted into the first preform with the helical portion arranged as a spring being under tension, or under compression, or under neutral compression/tension.

In addition to one or more of the features described above, or as an alternative to any of the foregoing embodiments, the method can further comprise compressing the first preform and inserted second preform.

In addition to one or more of the features described above, or as an alternative to any of the foregoing embodiments, compression of the inserted second preform can include a helical compression of the portion of the second preform arranged as a spring.

In addition to one or more of the features described above, or as an alternative to any of the foregoing embodiments, the second preform can comprise ceramic fibers and an organic polymer resin, and the method includes pyrolyzing the organic polymer resin after compression and before infiltrating the matrix material.

In addition to one or more of the features described above, or as an alternative to any of the foregoing embodiments, the method can further comprise compressing the first preform before infiltrating the matrix material.

In addition to one or more of the features described above, or as an alternative to any of the foregoing embodiments, the second preform can comprise ceramic fibers and an organic polymer resin, and the method includes pyrolyzing the organic polymer resin before infiltrating the matrix material.

In addition to one or more of the features described above, or as an alternative to any of the foregoing embodiments, the method can further include applying an interface coating to the first preform, or to the second preform, or to the first preform and the second preform before infiltrating the matrix material.

In addition to one or more of the features described above, or as an alternative to any of the foregoing embodiments, infiltrating can comprise chemical vapor infiltration, atomic layer deposition, polymer infiltration and pyrolysis, and/or melt infiltration.

A ceramic matrix composite is also disclosed. The ceramic matrix composite includes a first portion including a matrix comprising a ceramic, and a reinforcement including fibers derived from the first preform in the matrix. A second portion including a helical surface portion interface with the first portion is disposed within the first portion.

In addition to one or more of the features described above, or as an alternative to any of the foregoing embodiments, the second portion can comprise a matrix comprising a ceramic, and a reinforcement comprising fibers in said matrix, said fibers derived from a second.

In addition to one or more of the features described above, or as an alternative to any of the foregoing embodiments, the helical surface portion can include a portion arranged as a screw.

In addition to one or more of the features described above, or as an alternative to any of the foregoing embodiments, the helical surface portion includes a helical portion arranged as a spring.

Also disclosed is a gas turbine engine component including a ceramic matrix composite that includes a first portion including a matrix comprising a ceramic, and a reinforcement including fibers derived from the first preform in the matrix. A second portion including a helical surface portion interface with the first portion is disposed within the first portion.

### BRIEF DESCRIPTION OF THE DRAWINGS

The following descriptions should not be considered limiting in any way. With reference to the accompanying drawings, like elements are numbered alike:

FIG. 1 schematically shows a fiber preform;

FIG. 2 schematically shows a preform with a helical surface portion;

FIG. 3 schematically shows insertion of a helical preform into the preform of FIG. 1;

FIG. 4 schematically shows the preform of FIG. 1 with the helical preform fully inserted;

FIG. 5 schematically shows a preform with an inserted helical preform under compression;

FIG. 6 schematically shows a fiber preform after compression, ready for infiltration with a matrix material;

FIG. 7 schematically shows the fiber preform with infiltrated matrix material; and

FIG. 8 is a partial cross-sectional view of a gas turbine engine.

### DETAILED DESCRIPTION

A detailed description of one or more embodiments of the disclosed apparatus and method are presented herein by way of exemplification and not limitation with reference to the Figures.

A ceramic matrix composite (“CMC”) can be made by infiltrating a preform using matrix material such as by chemical vapor infiltration. The fiber preform contributes beneficial mechanical properties to the composite by providing reinforcement for a matrix material. Mechanical properties of interest include but are not limited to interlaminar shear strength (“ILS”) and interlaminar tensile strength (“ITS”). CMC's can be used for high-temperature applications (e.g., 2200° F. and above), and may be designated as ultra-high temperature ceramic matrix composites (“UHT-CMC”).

Exemplary CMC materials can include silicon-containing, or oxide containing matrix and reinforcing materials. Some examples of CMCs include, but are not limited to, materials having a matrix and reinforcing fibers comprising non-oxide silicon-based materials such as silicon carbide, silicon nitride, silicon oxycarbides, silicon oxynitrides, silicides, and mixtures thereof. Examples include, but are not limited to, CMCs with a silicon carbide matrix and silicon carbide fiber; silicon nitride matrix and silicon carbide fiber; and silicon carbide/silicon nitride matrix mixture and silicon carbide fiber. Furthermore, CMCs can have a matrix and reinforcing fibers including oxide ceramics. Specifically, the oxide-oxide CMCs may include a matrix and reinforcing fibers comprising oxide-based materials such as aluminum oxide (Al₂O₃), silicon dioxide (SiO₂), yttrium aluminum garnet (YAG), aluminosilicates, or mixtures comprising any of the foregoing. Aluminosilicates can include crystalline materials such as mullite (3Al₂O₃ 2SiO₂), as well as glassy aluminosilicates. Other ceramic composite materials in addition to or in combination with silicon or oxygen may be used, including carbon, carbides (e.g., zirconium carbide, hafnium carbide, boron carbide), nitrides, or other ceramic materials, alone or in combinations including any of the materials noted above.

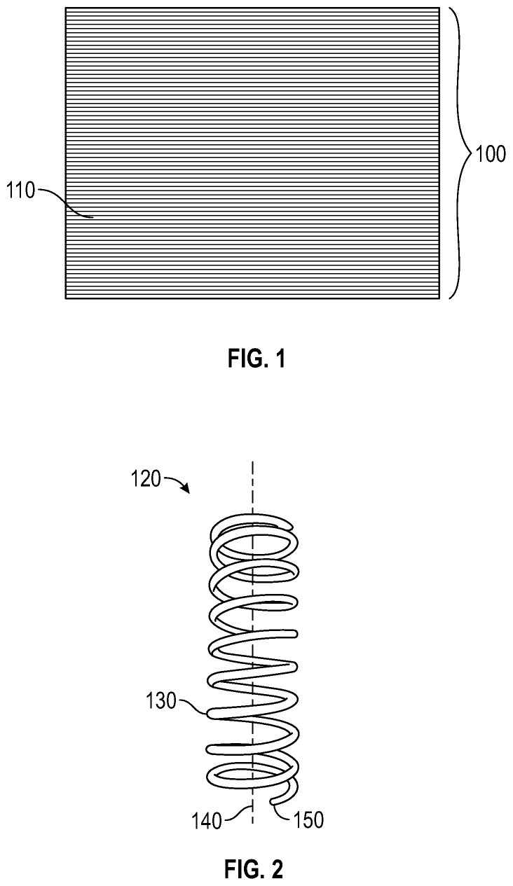

Referring to FIG. 1, a first preform 100 is shown according to various embodiments. As shown in FIG. 1, the preform 100 includes a plurality of fiber tows or plies 110). Each fiber tow or ply 110 can include a plurality of individual fibers (e.g., from 100 to 500 fibers per tow). In various aspects, the fiber tows or plies 110 can be arranged in a 1-D tape or a 2-D fabric, and layers of tape or woven or unwoven fabric can be stacked in layup (including stacked layups of 2-D fabrics such as a woven fabric and also stacked layups of 1-D tape or 2-D non-woven fabric) in order to form the preform 100. Alternatively, a 3-D fabric can be woven or otherwise arranged from continuous or non-continuous fibers. The fibers can include any material typically used in CMC processing, such as carbon, alumina, silicon carbide, silicon nitride-carbide, zirconia, zirconium carbide, boron carbide, glass, or mullite. In some aspects, such as for high-temperature applications like gas turbine engine hot section components, fibers capable of withstanding specified temperatures can be used, including but not limited to ceramic fibers such as silicon carbide, alumina, zirconia, boron carbide, zirconium carbide, hafnium carbide. In some aspects, the fibers can include an interface coating (e.g., a boron nitride coating on a silicon carbide fiber). However, in other aspects the fibers can be bare fibers, in which case the fibers would not include an interface coating.

With reference now to FIG. 2, a second preform including a helical surface portion is shown in the form of a helical compression spring 120. Of course, the helical compression spring 120 is an example embodiment, and the second preform can include other types of helical surface portions. For example, the helical compression spring 120 includes a curvilinear-extending spring member 130 that extends along a helical path about an axis 140. The compression spring includes a hollow space at and about the axis 140, but the second preform could be solid at the axis 140 or include a solid annulus about the axis 140, with the helical surface portion arranged in the form of a shaft twisting spiral rectangular shaft, or arranged as helical threads extending from a solid linear shaft or annulus. In some aspects, the helical surface portion of the second member can be arranged to function as a screw. As used herein, the term “screw” refers to the simple machine its operation that converts between linear motion and rotational motion, and between rotational force (i.e., torque) and linear force. The compression spring 120 is an example of a screw, and can be inserted into the preform 100 by rotating the compression spring 120 so that leading tip 150 follows a helical path into the preform.

The compression spring 120 can be formed from materials to provide a target resiliency for conversion of stress and strain. In some aspects, the compression spring 120 can be formed from fibers and an elastomeric or flexible matrix polymer. The matrix polymer can be any type of polymer, including but not limited to epoxy, polyurethane, a polystyrene, polypropylene, polyethylene, etc. The fibers can be any of the fibers disclosed above, and can be the same as or of different composition compared to the fibers used in the first preform. The fibers in the second preform can be chopped and dispersed in the matrix polymer, or they can be extruded as continuous fibers extending co-linearly along the helical extension of the spring member 130.

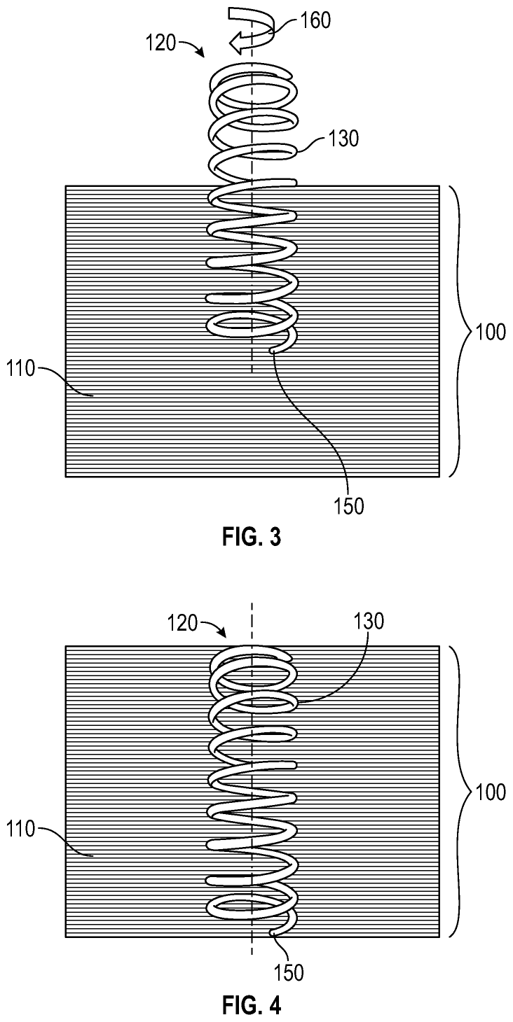

In some aspects, the compression spring 120 can be inserted in a Z-direction into the preform 100 as schematically shown in FIG. 3 (e.g., by screwing in with rotation in the direction of arrow 160). In some aspects, this rotational insertion can provide a technical effect of promoting reduced breakage of fibers during insertion compared to other reinforcement techniques such as z-pinning. In some aspects, the compression spring 120 can be inserted into the preform 100 so that compression spring is under tension. In some aspects, the compression spring 120 can be inserted into the preform 100 so that the compression spring is under compression. In some aspects, the compression spring 120 can be inserted into the preform 100 so that compression spring is under neither compression nor tension (i.e., neutral compression/tension).

During some aspects of processing (e.g., compression of the preforms prior to and during matrix infiltration and consolidation), the compression spring 120 may undergo helical deformation in response to an application of linear stress. As used herein, the term “helical deformation” means changes in the parameters of the helix such as pitch (axial distance corresponding to one complete turn of the helix), arc length, curvature, torsion to accommodate stress applied along the axis 140 and resulting deformation of a spring or spring-like structure in response to axial stress. In some aspects, the second preform can utilize an elastomeric matrix polymer to provide a resilient compression spring 120. However, in some aspects, one-way deformation during processing, but absorption of compressive load by a resilient spring including shape recovery may not be needed if the performance of the preform is satisfied by placing reinforcing fibers along the helical insertion path of the second member. In such cases, the polymer matrix for the second member need not be elastomeric, but can instead provide a level of flexibility (in combination with the mechanical properties of the fibers in the second preform), that is sufficiently low to maintain its shape during insertion and to prevent deflection of the leading tip 150, and also sufficiently high to tolerate deformation such as in response to compression along the axis 140. FIG. 4 shows the compression spring 120 fully inserted in the Z-direction into the preform 100.

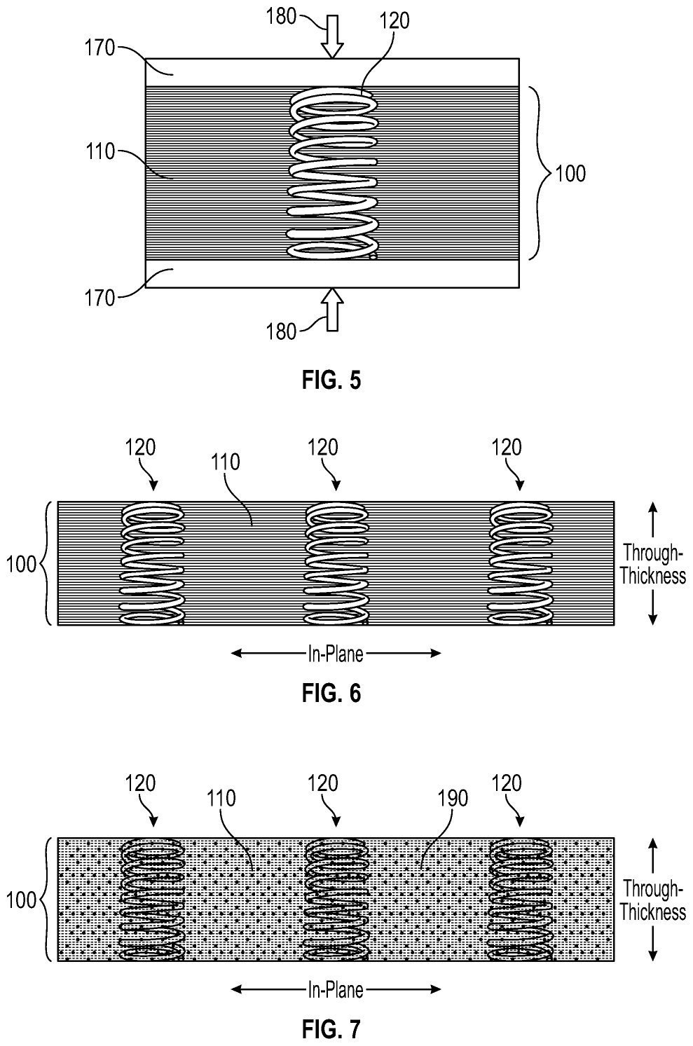

In FIG. 5, the preform 100 with the inserted second preform in the form of the compression spring 120 is shown disposed between tooling 170 and subjected to a compression load in the direction of arrows 180. Compression of a preform before matrix infiltration/consolidation can beneficially promote high fiber volume in final composite, but can cause problems for conventional z-pinning schemes, including but not limited to breaking of fibers, and crimping or other damage to fibers, which can adversely impact the mechanical and performance properties of the composite. However, the compression spring 120 accommodates the stress from the compressive load 180 with helical deformation including a change in helical pitch with shorter axial distances between each turn of the helix as shown in FIG. 5, which can promote reduced susceptibility to breaking of fibers, crimping, or other damage to fibers. A final preform structure after compression, with three compression springs 120 inserted into the preform 100, is shown in FIG. 6.

Any polymer resin in the second preform (and also any polymer resin in the first preform) can be pyrolyzed thermally decomposed, also known as burn-out, before infiltration of the matrix material. In cases where a fiber matrix interface coating is applied to the preforms, any polymer resin can be thermally decomposed before application of the fiber matrix interface coating. Thermal decomposition of polymer resin can be performed at temperatures of 200-700° C. in an oxidizing, inert, or vacuum environment.

In some aspects, a fiber/matrix interface coating can optionally be applied before matrix consolidation. In some aspects, a fiber/matrix interface coating can promote reduction in formation or propagation of cracks by allowing the fiber to slide in the interface coating at the fiber-coating interface or by allowing the coated fiber to move in the matrix by sliding at the coating-matrix interface. The choice of material for a fiber/matrix interface coating depends on the materials of the fibers and the matrix. For example, in the case of silicon carbide fibers and a silicon carbide matrix, the fibers may be coated with boron nitride as a fiber/matrix interface coating. A matrix/fiber interface coating can be applied by known means such as chemical vapor infiltration or atomic layer deposition, which can promote a uniform thickness coating and can infiltrate fine spaces in the preform(s).

With any polymers thermally decomposed, and a fiber/matrix interface coating applied (if desired), the preforms are ready for matrix consolidation. Matrix consolidation is typically performed by infiltration of the preforms with a matrix material. For example, in some aspects, the preforms can be treated with chemical vapor infiltration (CVI) in which a gas comprising a matrix material precursor (e.g., CH₃SiCl₃—H₂) in a carrier gas at elevated temperature is infiltrated into the void space in the preforms and consolidates there to form a ceramic matrix material (e.g., SiC). The resultant composite, including fiber tows or plies 110 derived from the preform 100, fiber reinforcements derived from second preforms in the form of compression springs 120, and matrix material 190 is shown in FIG. 7.

The method described herein can be used to prepare a variety of components comprising ceramic matrix composites such as components in the aviation industry, marine industry and energy industry. Exemplary components include components for gas turbine engines, such as in high pressure compressors (“HPC”), fans, boosters, high pressure turbines (“HPT”), and low pressure turbines (“LPT”). More specifically exemplary components include combustion liners, shrouds, nozzles, and blades. In addition to the above-referenced technical effect of reduced fiber breakage, the reinforcement provided to the composite by the second preform can promote additional technical effects, including but not limited to promotion of improved interlaminar shear strength (“ILS”) and/or improvement of interlaminar tensile strength (“ILT”).

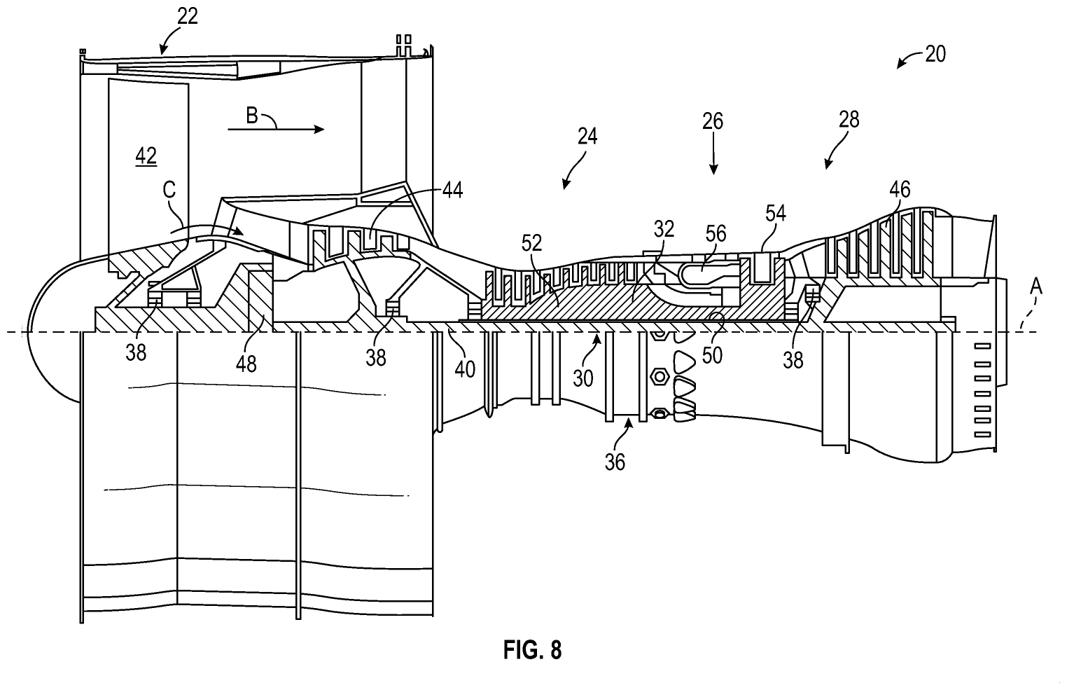

FIG. 8 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (TSFC′)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of making a ceramic matrix composite, comprising:
forming a first preform comprising fibers;
inserting a second preform including a helical surface portion into the first preform; and
infiltrating a matrix material comprising a ceramic into the first preform to form the ceramic matrix composite.

2. The method of claim 1, wherein the first preform comprises a three-dimensional woven fiber preform or a stacked fiber layup.

3. The method of claim 2, wherein the first preform comprises a stacked layup of fibers including a Z-axis perpendicular to layers in the stacked layup, and the second preform is inserted with a helical axis of said helical surface portion arranged parallel to the Z-axis.

4. The method of claim 1, further comprising rotating the second preform about an axis of the helix in a rotational direction that promotes advancement of the helical surface through the first preform.

5. The method of claim 4, wherein axial movement of the second member with said insertion is equal to axial distance traveled by said helical surface portion in response to said rotation.

6. The method of claim 1, wherein the helical surface portion includes a portion arranged as a screw.

7. The method of claim 1, wherein the helical surface portion includes a helical portion arranged as a spring.

8. The method of claim 7, wherein the second preform is inserted into the first preform with the helical portion arranged as a spring being under tension, or under compression, or under neutral compression/tension.

9. The method of claim 7, further comprising compressing the first preform and inserted second preform.

10. The method of claim 9, wherein compression of the inserted second preform includes a helical compression of the portion of the second preform arranged as a spring.

11. The method of claim 9, wherein the second preform comprises ceramic fibers and an organic polymer resin, and the method includes pyrolyzing the organic polymer resin after compression and before infiltrating the matrix material.

12. The method of claim 1, further comprising compressing the first preform before infiltrating the matrix material.

13. The method of claim 1, wherein the second preform comprises ceramic fibers and an organic polymer resin, and the method includes pyrolyzing the organic polymer resin before infiltrating the matrix material.

14. The method of claim 1, further including applying an interface coating to the first preform, or to the second preform, or to the first preform and the second preform before infiltrating the matrix material.

15. The method of claim 1 wherein infiltrating comprises chemical vapor infiltration, atomic layer deposition, polymer infiltration and pyrolysis, and/or melt infiltration.

16. A ceramic matrix composite, comprising:
a first portion including a matrix comprising a ceramic, and a reinforcement comprising fibers in said matrix, said fibers derived from a first preform; and
a second portion within the first portion, the second portion including a helical surface portion interface with the first portion.

17. The ceramic matrix composite of claim 16, wherein the second portion comprises a matrix comprising a ceramic, and a reinforcement comprising fibers in said matrix, said fibers derived from a second.

18. The ceramic matrix composite of claim 16, wherein the helical surface portion includes a portion arranged as a screw.

19. The ceramic matrix composite of claim 16, wherein the helical surface portion includes a helical portion arranged as a spring.

20. A gas turbine engine component, comprising:
a first portion including a matrix comprising a ceramic, and a reinforcement comprising fibers in said matrix, said fibers derived from a first preform; and
a second portion within the first portion, the second portion including a helical surface portion interface with the first portion.
